(19) United States
(12) Patent Application Publication
(10) Pub. No.: US 2026/0260096 A1
(43) Pub. Date: Sep. 3, 2026

(54) INFORMATION PROCESSING APPARATUS, INFORMATION PROCESSING METHOD, AND NON-TRANSITORY RECORDING MEDIUM

(71) Applicants: Dai Nakashima, Tokyo (JP); Yuta Nozaki, Kanagawa (JP); Ryo Sato, Kanagawa (JP); Naoki Asaba, Kanagawa (JP); Shintaro Kawamura, Kanagawa (JP)

(72) Inventors: Dai Nakashima, Tokyo (JP); Yuta Nozaki, Kanagawa (JP); Ryo Sato, Kanagawa (JP); Naoki Asaba, Kanagawa (JP); Shintaro Kawamura, Kanagawa (JP)

(73) Assignee: Ricoh Company, Ltd., Tokyo (JP)

(21) Appl. No.: 19/545,603

(22) Filed: Feb. 20, 2026

(30) Foreign Application Priority Data
Feb. 28, 2025 (JP) 2025-030943
Oct. 20, 2025 (JP) 2025-176679

(51) Int. Cl. G06N 3/045; G06N 3/0475

(52) U.S. Cl. CPC G06N 3/045; G06N 3/0475

(57) ABSTRACT

An information processing apparatus includes circuitry to integrate a first language model, a second language model, and a fourth language model to generate an integrated model. The first language model is generated by applying a vocabulary modification to an input layer and an output layer of a base language model. The second language model is generated by performing continued pretraining on the first language model. The fourth language model is generated by applying a vocabulary modification that is substantially the same as the vocabulary modification used for generation of the first language model to an input layer and an output layer of a third language model. The third language model is generated by performing instruction tuning on the base language model.

### CROSS-REFERENCE TO RELATED APPLICATIONS

This patent application is based on and claims priority pursuant to 35 U.S.C. §119(a) to Japanese Patent Application Nos. 2025-030943, filed on February 28, 2025, and 2025-176679, filed on October 20, 2025, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

In a related technique, a chat vector (a difference between a base model and a model that has acquired instruction-following performance through instruction tuning of the base model) is merged with a model (CP model) obtained by continued pretraining of the base model, thereby generating a model (target LM) that has acquired instruction-following capability while retaining characteristics of the CP model.

### SUMMARY

The present disclosure described herein provides an information processing apparatus including circuitry to circuitry to integrate a first language model, a second language model, and a fourth language model, to generate an integrated model. The first language model is generated by applying a vocabulary modification to an input layer and an output layer of a base language model. The second language model is generated by performing continued pretraining on the first language model. The fourth language model is generated by applying a vocabulary modification that is substantially the same as the vocabulary modification used for generation of the first language model to an input layer and an output layer of a third language model. The third language model is generated by performing instruction tuning on the base language model.

The present disclosure described herein provides an information processing method including integrating a first language model, a second language model, and a fourth language model, to generate an integrated model. The first language model is generated by applying a vocabulary modification to an input layer and an output layer of a base language model. The second language model is generated by performing continued pretraining on the first language model. The fourth language model is generated by applying a vocabulary modification that is substantially the same as the vocabulary modification used for generation of the first language model to an input layer and an output layer of a third language model. The third language model is generated by performing instruction tuning on the base language model.

The present disclosure described herein provides a non-transitory recording medium storing a plurality of instructions which, when executed by one or more processors, causes the one or more processors to perform a method including integrating a first language model, a second language model, and a fourth language model, to generate an integrated model. The first language model is generated by applying a vocabulary modification to an input layer and an output layer of a base language model. The second language model is generated by performing continued pretraining on the first language model. The fourth language model is generated by applying a vocabulary modification that is substantially the same as the vocabulary modification used for generation of the first language model to an input layer and an output layer of a third language model. The third language model is generated by performing instruction tuning on the base language model.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of an information processing system;

FIG. 2 is a diagram illustrating a hardware configuration of a server and a personal computer (PC);

FIG. 3 is a block diagram illustrating a functional configuration of a server and a PC;

FIG. 4 is a conceptual diagram of an integrated model generation process performed by the server illustrated in FIG. 3;

FIG. 5 is a diagram illustrating a vocabulary modification performed by the server illustrated in FIG. 3;

FIG. 6 is a diagram illustrating model integration performed by the server illustrated in FIG. 3;

FIG. 7 is a diagram illustrating model integration performed by the server using a chat vector;

FIG. 8 is a conceptual diagram of an integrated model generation process according to a first modification;

FIG. 9 is a conceptual diagram of an integrated model generation process according to a second modification;

FIG. 10 is a diagram illustrating a relationship between each language model and an embedding layer;

FIG. 11 is a diagram illustrating a change of the embedding layer in each language model;

FIG. 12 is a diagram illustrating a matrix of an embedding layer of a merged model (integrated model);

FIG. 13 is a diagram illustrating another matrix of the embedding layer of the merged model (integrated model);

FIG. 14 is a conceptual diagram of an integrated model generation process according to a third modification;

FIG. 15 is a diagram illustrating a user interface (UI) screen displayed by a PC for receiving input of a dataset;

FIG. 16 is a block diagram illustrating a functional configuration of a server and a PC;

FIG. 17 is a flowchart of a procedure of a generative artificial intelligence (AI) chat process performed by the server and the PC;

FIG. 18 is a diagram illustrating a generative AI chat screen displayed on a PC; and

FIG. 19 is a diagram illustrating a generative AI chat screen displayed on a PC.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

### System Configuration of Information Processing System 10

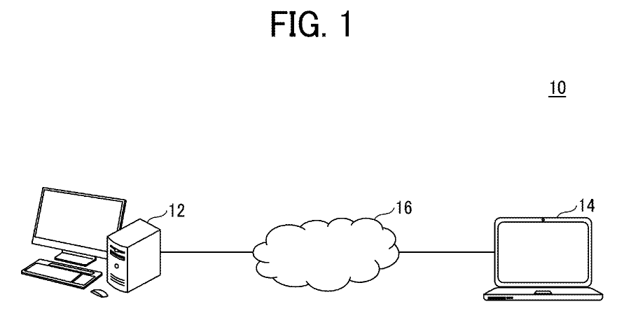

FIG. 1 is a diagram illustrating a system configuration of an information processing system 10.

The information processing system 10 illustrated in FIG. 1 is an example of an “information processing system.” The information processing system 10 includes a server 12 and a personal computer (PC) 14. The server 12 and the PC 14 are communicably connected to each other via a communication network 16. Examples of the communication network 16 include a local area network (LAN) and the Internet.

The PC 14 is an example of a terminal apparatus. The PC 14 includes an input device for inputting a character string. Examples of the input device include, but are not limited to, a keyboard and a touch panel. The PC 14 transmits a character string input by a user using the input device to the server 12 via the communication network 16. The PC 14 may have a speech recognition function for recognizing speech input by the user via a microphone. In this case, the PC 14 may transmit a character string representing speech recognized by the speech recognition function to the server 12.

The server 12 is an example of an “information processing apparatus.” The server 12 receives the character string transmitted from the PC 14 via the communication network 16, and performs character string segmentation to divide the character string into vocabulary items in the units that can be handled by the model.

Specifically, the server 12 includes a tokenizer. The tokenizer has a vocabulary set. The vocabulary set includes multiple vocabulary items (e.g., a word, a subword, a character), each of which is associated with an identifier. In the following description, such vocabulary items may be referred to as “words.” The vocabulary set is implemented by, for example, a JavaScript Object Notation (JSON) file. Based on the vocabulary set, the tokenizer performs character string segmentation (i.e., tokenization) using any desired technique on a character string acquired from the PC 14 to divide the character string acquired from the PC 14 into vocabulary items (i.e., multiple morphemes). The tokenizer outputs identifiers corresponding to the multiple divided vocabulary items to a large language model (LLM).

The PC 14 receives the vocabulary items (i.e., the vocabulary items acquired by character string segmentation) transmitted from the server 12 via the communication network 16 and performs various processing operations using the vocabulary items.

In the example illustrated in FIG. 1, a single terminal apparatus (i.e., the PC 14) is connected to the server 12 via the communication network 16. In practice, in the information processing system 10, multiple terminal apparatuses are connectable to the server 12 via the communication network 16, and a character string is transmittable from each of the multiple terminal apparatuses to the server 12.

In the example illustrated in FIG. 1, the PC 14 is used as an example of a terminal apparatus for receiving a character string as input. However, the terminal apparatus is not limited thereto, and may be another apparatus (e.g., a smartphone, a tablet terminal, an electronic whiteboard, an inkjet printer, a multifunction peripheral (MFP), a videoconference terminal, a projector, or a spherical image capturing device) as long as such an apparatus can at least receive a character string as input and transmit the character string.

### Hardware Configuration of Server 12 and PC 14

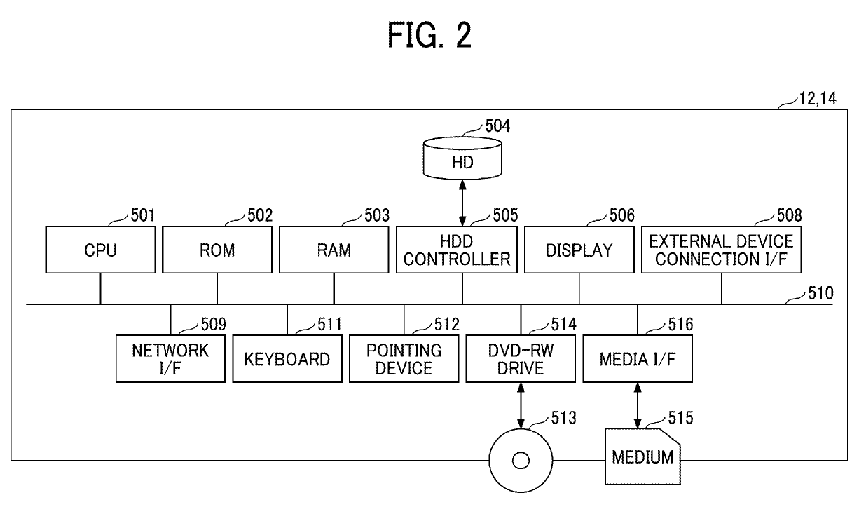

FIG. 2 is a diagram illustrating a hardware configuration of the server 12 and the PC 14. A hardware configuration common to the server 12 and the PC 14 will be described.

The server 12 and the PC 14 are each implemented by a computer. As illustrated in FIG. 2, the server 12 and the PC 14 each include a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a digital versatile disk rewritable (DVD-RW) drive 514, and a media I/F 516.

The CPU 501 controls an overall operation of the server 12 or the PC 14. The ROM 502 stores a program used for booting the CPU 501, such as an initial program loader (IPL). The RAM 503 is used as a work area for the CPU 501. The HD 504 stores various types of data such as programs. The HDD controller 505 controls the reading or writing of various types of data from or to the HD 504 under the control of the CPU 501. The display 506 displays various types of information such as a cursor, a menu, a window, characters, or images. The external device connection I/F 508 is an interface for connecting to various external devices. Examples of the external device include, but are not limited to, a Universal Serial Bus (USB) memory and a printer. The network I/F 509 is an interface for performing data communication using the communication network 16. The data bus 510 is, for example, an address bus or a data bus that electrically connects the components illustrated in FIG. 2, such as the CPU 501, to one another.

The keyboard 511 is an example of an input device including keys to input characters, numerical values, various instructions, and the like. The pointing device 512 is an example of an input device to allow a user to select or execute various instructions, select a target to be processed, or move a cursor being displayed. The DVD-RW drive 514 controls the reading or writing of various types of data from or to a DVD-RW 513, which is an example of a removable recording medium. The removable recording medium is not limited to a DVD-RW and may be digital versatile disc-recordable (DVD-R) or the like. The media I/F 516 controls reading or writing (storing) of data from or to a recording medium 515 such as flash memory.

### Functional Configuration of Server 12 and PC 14

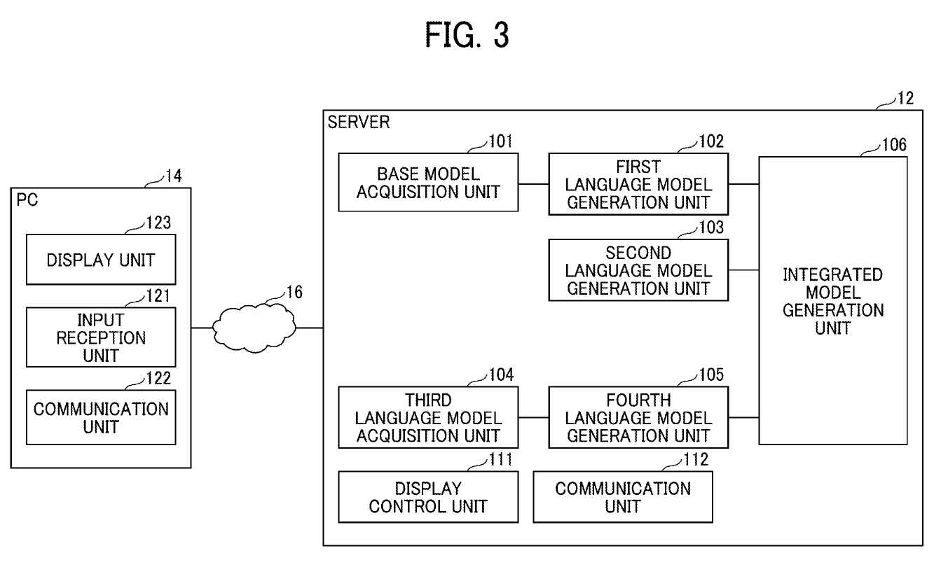

FIG. 3 is a block diagram illustrating a functional configuration of the server 12 and the PC 14. FIG. 3 illustrates multiple functions related to generation of an integrated model among multiple functions of the server 12 and the PC 14. Each model described below refers to an LLM.

As illustrated in FIG. 3, the server 12 includes a base model acquisition unit 101, a first language model generation unit 102, a second language model generation unit 103, a third language model acquisition unit 104, a fourth language model generation unit 105, and an integrated model generation unit 106.

The base model acquisition unit 101 acquires a base model that is a base language model. For example, the base model acquisition unit 101 acquires an available open model (e.g., Meta-Llama-3) as the base model from the outside (e.g., via the Internet or the like).

The first language model generation unit 102 applies a vocabulary modification to input and output layers of the base model acquired by the base model acquisition unit 101 to generate a first language model.

The input and output layers correspond to an embedding layer (hereinafter also referred to as an input layer) and an LM_head layer (also referred to as an output layer) in an LLM. The embedding layer is a layer that converts identifiers corresponding to character strings obtained through division by a tokenizer into corresponding embedding vectors. The LM_head layer is a layer that outputs a vector sequence (prediction probabilities of identifiers corresponding to the respective character strings as next tokens) based on processing by a hidden layer (hereinafter also referred to as an intermediate layer) of the LLM. Applying a vocabulary modification to the input and output layers refers to modifying, in the input and output layers, an association between an identifier corresponding to a character string and a vector in accordance with a vocabulary modification for a tokenizer. A vocabulary modification in the tokenizer includes vocabulary expansion (newly adding an association between a vocabulary item and an identifier), reduction (deleting an association between a vocabulary item and an identifier), and replacement (changing a vocabulary item associated with a certain identifier to another vocabulary item). That is, a vocabulary modification at the input and output layers includes vocabulary expansion (adding an identifier added by a vocabulary modification of the tokenizer and a vector corresponding to the identifier), reduction (deleting an identifier deleted by a vocabulary modification of the tokenizer and a vector corresponding to the identifier), and replacement (changing a vector associated with an identifier with which a vocabulary item to be associated has been changed by a vocabulary modification of the tokenizer to another vector).

The second language model generation unit 103 performs continued pretraining on the first language model generated by the first language model generation unit 102 to generate a second language model. Continued pretraining refers to the process of further training a pretrained model, which has already been trained on a large-scale dataset, on an additional large-scale dataset. For example, continued pretraining is used for localization of a model for English into Japanese, specialization in domains such as a financial domain or a medical domain, or the like.

The third language model acquisition unit 104 acquires a third language model. The third language model is generated by performing instruction tuning on the base model. For example, the third language model acquisition unit 104 acquires, as the third language model, an available open model (e.g., Meta-Llama3-Instruct) from the outside (e.g., via the Internet or the like). Instruction tuning refers to the process of further training a pretrained model (or model subjected to continued pretraining) using a small amount of task-specific dataset. For example, instruction tuning is used particularly to enable classification, summarization, and responses in a chat format.

The fourth language model generation unit 105 applies a vocabulary modification similar to the vocabulary modification performed by the first language model generation unit 102 to input and output layers of the third language model generated by the third language model acquisition unit 104 to generate a fourth language model. The vocabulary modification similar to the vocabulary modification performed by the first language model generation unit 102 is to perform vocabulary expansion, reduction, and replacement in a way similar to that in the vocabulary modification performed by the first language model generation unit 102. That is, the vocabulary reduction is performed by deleting an association between an identifier and a vector that has been reduced by the first language model generation unit 102, and the vocabulary expansion and replacement are performed by associating a vector generated by the same calculation method as that of the first language model generation unit 102 with an identifier indicating a new or existing vocabulary item.

The integrated model generation unit 106 generates an integrated model by integrating the first language model generated by the first language model generation unit 102, the second language model generated by the second language model generation unit 103, and the fourth language model generated by the fourth language model generation unit 105.

As illustrated in FIG. 3, the server 12 further includes a communication unit 112 and a display control unit 111.

The communication unit 112 performs communication with the PC 14. For example, the communication unit 112 receives input from the user through the PC 14. For example, the communication unit 112 transmits screen information for displaying a user interface (UI) screen to the PC 14 under the control of the display control unit 111.

The display control unit 111 controls screen display on the PC 14. Specifically, the display control unit 111 transmits screen information for displaying a UI screen to the PC 14 via the communication unit 112 to display the UI screen on the PC 14.

As illustrated in FIG. 3, the PC 14 includes an input reception unit 121, a communication unit 122, and a display unit 123.

The input reception unit 121 receives input from the user on a UI screen displayed on the display unit 123.

The communication unit 122 performs communication with the server 12. For example, the communication unit 122 transmits input from the user, which is received by the input reception unit 121, to the server 12. For example, the communication unit 122 receives screen information for displaying a UI screen from the server 12.

The display unit 123 displays a UI screen based on the screen information received by the communication unit 122.

Each of the functions in the above-described embodiments may be implemented by one or more pieces of processing circuitry. As used herein, the term “processing circuitry” is used to include processors programmed to implement each function by software, such as a processor implemented by an electronic circuit, and devices designed to implement the functions described above, such as an application-specific integrated circuit (ASIC), a digital signal processor (DSP), a field-programmable gate array (FPGA), and existing circuit modules.

### Integrated Model Generation Process by Server 12

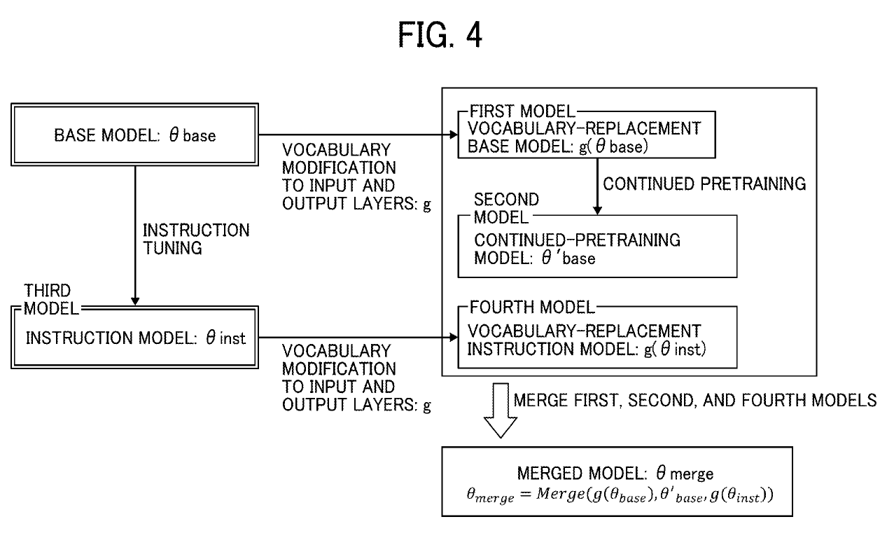

FIG. 4 is an illustration of an integrated model generation process performed by the server 12.

In the integrated model generation process illustrated in FIG. 4, first, the base model acquisition unit 101 acquires a base model θ_{base}.

Subsequently, the first language model generation unit 102 applies a vocabulary modification g to input and output layers of the base model θ_{base} acquired by the base model acquisition unit 101 to generate a vocabulary-replacement base model g(θ_{base}) (first language model).

Subsequently, the second language model generation unit 103 performs continued pretraining on the vocabulary-replacement base model g(θ_{base}) generated by the first language model generation unit 102 to generate a continued-pretraining model θ'_{base} (second language model).

Subsequently, the third language model acquisition unit 104 acquires an instruction model θᵢₙₛₜ (third language model) generated by performing instruction tuning on the base model θ_{base}.

Subsequently, the fourth language model generation unit 105 applies a vocabulary modification g similar to the vocabulary modification g performed by the first language model generation unit 102 to input and output layers of the instruction model θᵢₙₛₜ acquired by the third language model acquisition unit 104 to generate a vocabulary-replacement instruction model g(θᵢₙₛₜ) (fourth language model).

The integrated model generation unit 106 integrates the vocabulary-replacement base model g(θ_{base}) (first language model) generated by the first language model generation unit 102, the continued-pretraining model θ'_{base} (second language model) generated by the second language model generation unit 103, and the vocabulary-replacement instruction model g(θᵢₙₛₜ) (fourth language model) generated by the fourth language model generation unit 105 to generate a merged model θ_{merge} (integrated model). The merged model θ_{merge} (integrated model) is a model that has acquired instruction-following capability similar to that of the instruction model θᵢₙₛₜ (third language model) while retaining characteristics of the continued-pretraining model θ'_{base} (second language model).

The integrated model generation process illustrated in FIG. 4 is intended to integrate the continued-pretraining model θ'_{base} (second language model) generated by applying the vocabulary modification g to the base model θ_{base} and further performing continued pretraining with the vocabulary-replacement instruction model g(θᵢₙₛₜ) (fourth language model), thereby omitting instruction tuning, which is used for generation of the instruction model θᵢₙₛₜ (third language model).

In the integrated model generation process illustrated in FIG. 4, therefore, to generate the vocabulary-replacement instruction model g(θᵢₙₛₜ) (fourth language model), the server 12 applies a vocabulary modification g similar to that for the base model θ_{base} to the instruction model θᵢₙₛₜ to make the input and output layers of the instruction model θᵢₙₛₜ coincide with the input and output layers of the base model θ_{base}.

In the server 12, the merging processing further includes the vocabulary-replacement base model g(θ_{base}) (first language model) in order to extract an effect of the instruction tuning (i.e., a difference between the instruction model θᵢₙₛₜ (third language model) and the base model θ_{base}), which is used when the instruction model θᵢₙₛₜ (third language model) is generated, from the vocabulary-replacement instruction model g(θᵢₙₛₜ) (fourth language model).

For the above reasons, in the integrated model generation process illustrated in FIG. 4, the server 12 generates the merged model θ_{merge} (integrated model) by integrating the vocabulary-replacement base model g(θ_{base}) (first language model), the continued-pretraining model θ'_{base} (second language model), and the vocabulary-replacement instruction model g(θᵢₙₛₜ) (fourth language model).

Through the integrated model generation process illustrated in FIG. 4, the server 12 can generate the merged model θ_{merge} (integrated model) including an effect of the instruction tuning used when the instruction model θᵢₙₛₜ (third language model) is generated, after applying a vocabulary modification to the base model θ_{base} and further performing continued pretraining. Thus, the server 12 can generate the merged model θ_{merge} (integrated model) that has acquired instruction-following capability while retaining characteristics of the continued-pretraining model θ'_{base} (second language model).

In particular, through the integrated model generation process illustrated in FIG. 4, the server 12 can generate the merged model θ_{merge} (integrated model) including an effect of instruction tuning without performing time-consuming instruction tuning on the continued-pretraining model θ'_{base} (second language model). Thus, the merged model θ_{merge} (integrated model) that has acquired instruction-following capability can be generated with ease.

Instruction-following capability refers to the capacity to appropriately respond to instructions from a user. In particular, instruction-following capability is commonly used as a chat model's capacity to accurately follow instructions from a user or engage in natural conversations.

### Vocabulary Modification by Server 12

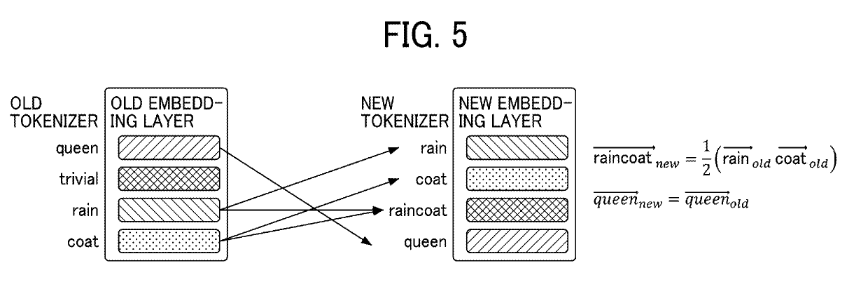

FIG. 5 is a diagram illustrating a vocabulary modification performed by the server 12.

In an example illustrated in FIG. 5, an old embedding layer includes identifiers each indicating a respective one of the words “queen,” “trivial,” “rain,” and “coat,” and vectors each associated with a respective one of the identifiers.

A new embedding layer includes identifiers each indicating a respective one of the words “rain,” “coat,” “raincoat,” and “queen,” and vectors each associated with a respective one of the identifiers.

Note that an embedding layer may have a vector in units of subwords divided from one word or one character, and the unit to which the identifier is given may be a subword or a token instead of a meaningful word. This identifier may be technically referred to as a token ID. The association between the identifier and the vector in the embedding layer may be referred to as a vocabulary.

Of the vocabulary items included in the new embedding layer, a vocabulary item common to the old embedding layer is linked to a vector common to the vector of the vocabulary item included in the old embedding layer. An identifier indicating a vocabulary item that is included in the new embedding layer but is not included in the old embedding layer (i.e., an added vocabulary item) is linked to a vector generated based on vectors of vocabulary items included in the old embedding layer. The vector generated based on vectors of vocabulary items included in the old embedding layer is, for example, a vector generated by an average or a weighted average of the vectors of the vocabulary items.

For example, in the example illustrated in FIG. 5, the identifier indicating the word “queen,” which is included in both the old embedding layer and the new embedding layer, is linked to a vector corresponding to the identifier indicating the word “queen” included in the old embedding layer.

For example, in the example illustrated in FIG. 5, the identifier indicating the word “raincoat,” which is included in the new embedding layer but is not included in the old embedding layer, is linked to an average of the vectors of the words “rain” and “coat” included in the old embedding layer.

For example, the first language model generation unit 102 of the server 12 applies a vocabulary modification using the method illustrated in FIG. 5 to the input and output layers of the base model to generate a first language model.

For example, the fourth language model generation unit 105 of the server 12 applies a vocabulary modification using the method illustrated in FIG. 5 to the input and output layers of the third language model to generate a fourth language model.

Through the integrated model generation process illustrated in FIG. 4, the server 12 can generate the merged model θ_{merge} (integrated model) including an effect of the instruction tuning used when the instruction model θᵢₙₛₜ (third language model) is generated, after applying a vocabulary modification to the base model θ_{base} and further performing continued pretraining. Thus, the server 12 can generate the merged model θ_{merge} (integrated model) that has acquired instruction-following capability.

### Concept of Model Integration

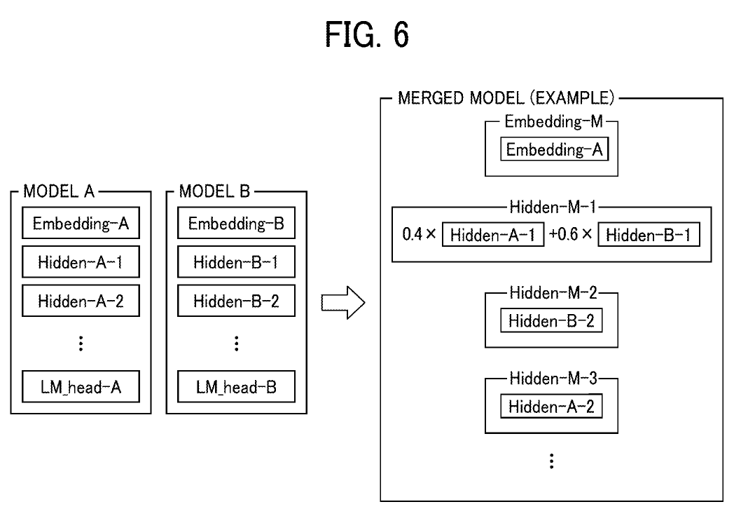

FIG. 6 is an illustration of model integration performed by the server 12.

FIG. 6 illustrates an example of generating an integrated model M by integrating a model A and a model B.

As illustrated in FIG. 6, each of the models A, B, and M has one embedding layer (input layer), multiple hidden layers (intermediate layers), and one LM_head layer (output layer). The total number of hidden layers of the integrated model M may change depending on the total number of hidden layers of the models A and B.

### Concept of Model Integration Using Chat Vector

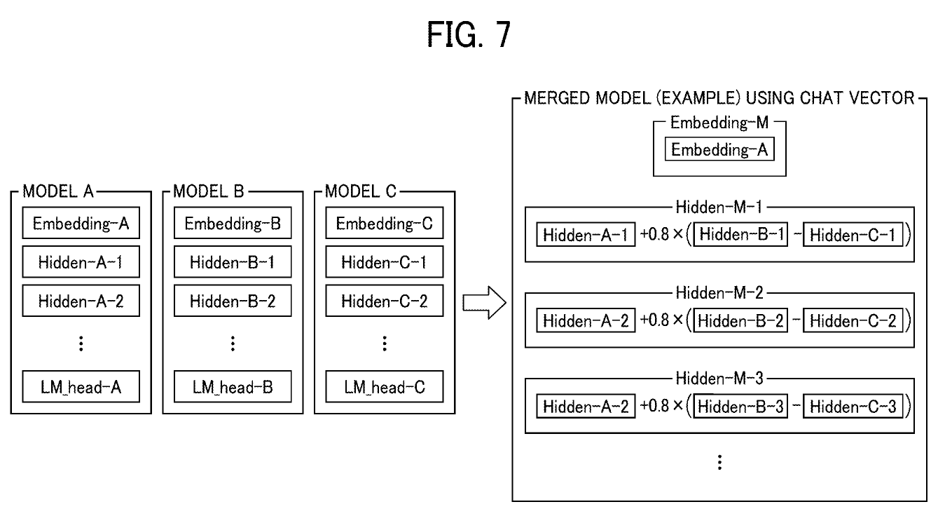

FIG. 7 is an illustration of model integration performed by the server 12 using a chat vector.

FIG. 7 illustrates an example of generating an integrated model M by adding a difference between a model B and a model C to a model A. The difference is referred to as a “chat vector.” As illustrated in FIG. 7, each of the models A, B, C, and M has one embedding layer (input layer), multiple hidden layers (intermediate layers), and one LM_head layer (output layer).

As illustrated in FIG. 7, when the chat vector is to be added to the model A, the chat vector is preferably multiplied by an appropriate real coefficient (in the example illustrated in FIG. 7, 0.8).

### First Modification of Integrated Model Generation Process by Server 12

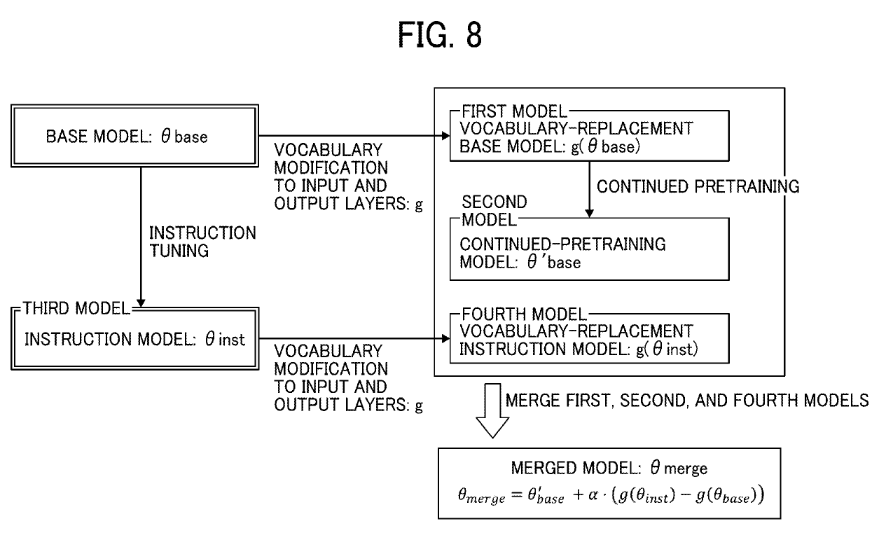

FIG. 8 is an illustration of a first modification of the integrated model generation process performed by the server 12.

In the integrated model generation process illustrated in FIG. 8, the integrated model generation unit 106 generates the merged model θ_{merge} (integrated model) by a different method from that in the integrated model generation process illustrated in FIG. 4.

Specifically, in the integrated model generation process illustrated in FIG. 8, the integrated model generation unit 106 generates the merged model θ_{merge} (integrated model) by adding, to the continued-pretraining model θ'_{base} (second language model) generated by the second language model generation unit 103, a product of a coefficient α (where α is a positive real number other than zero) and a difference (i.e., a chat vector) between the vocabulary-replacement instruction model g(θᵢₙₛₜ₎ (fourth language model) generated by the fourth language model generation unit 105 and the vocabulary-replacement base model g(θ_{base}) (first language model) generated by the first language model generation unit 102. The coefficient α is set to a desirable value according to the application of this disclosure.

The integrated model generation process illustrated in FIG. 8 enables the capacity (i.e., the instruction-following capability) of the instruction model θᵢₙₛₜ to be copied to the continued-pretraining model θ'_{base} (second language model).

### Second Modification of Integrated Model Generation Process by Server 12

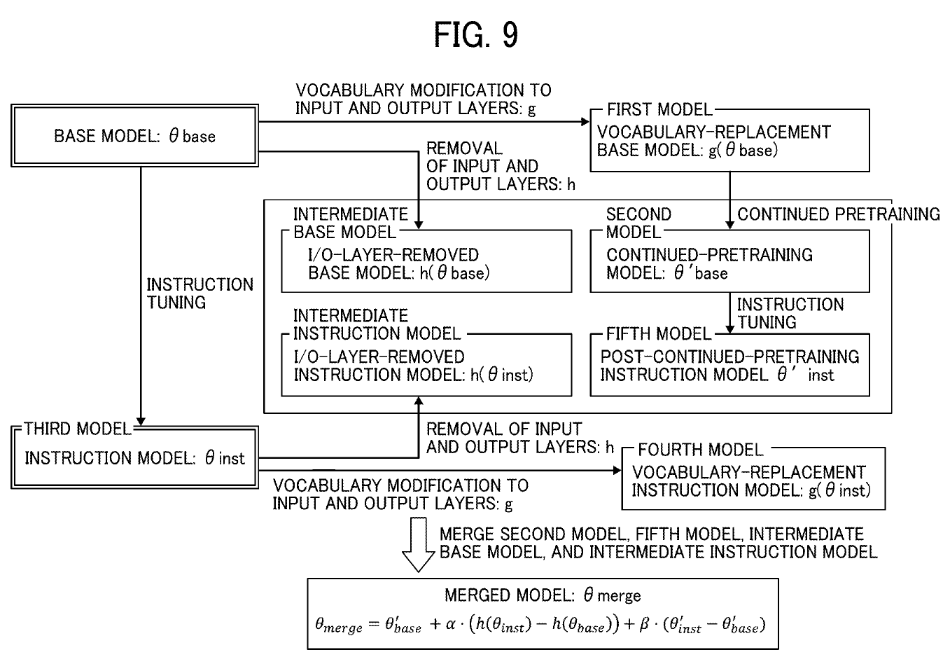

FIG. 9 is an illustration of a second modification of the integrated model generation process performed by the server 12.

The integrated model generation process illustrated in FIG. 9 is different from the integrated model generation process illustrated in FIG. 4 in the following points.

In the integrated model generation process illustrated in FIG. 9, the server 12 removes the input and output layers of the base model θ_{base} to generate an I/O-layer-removed base model h(θ_{base}) (an example of a “first intermediate model”).

The server 12 further removes the input and output layers of the instruction model θᵢₙₛₜ (third language model) to generate an I/O-layer-removed instruction model h(θᵢₙₛₜ) (an example of a “second intermediate model”).

Further, the server 12 performs instruction tuning on the continued-pretraining model θ'_{base} (second language model) to generate a post-continued-pretraining instruction model θ'ᵢₙₛₜ (fifth language model).

The integrated model generation unit 106 generates the merged model θ_{merge} (integrated model) by adding, to the continued-pretraining model θ'_{base} (second language model), a product of the coefficient α (where α is a positive real number other than zero) and a difference between the I/O-layer-removed instruction model h(θᵢₙₛₜ) and the I/O-layer-removed base model h(θ_{base}) and further a product of a coefficient β (where β is a positive real number other than zero) and a difference between the post-continued-pretraining instruction model θ'ᵢₙₛₜ (fifth language model) and the continued-pretraining model θ'_{base} (second language model). The coefficient β is set to a desirable value according to the application of this disclosure.

In the integrated model generation process illustrated in FIG. 9, the merging processing includes the difference between the I/O-layer-removed instruction model h(θᵢₙₛₜ) and the I/O-layer-removed base model h(θ_{base}). This enables the capacity (i.e., the instruction-following capability) of the instruction model θᵢₙₛₜ to be copied to the continued-pretraining model θ'_{base} (second language model) without applying the vocabulary modification g to the input and output layers of the instruction model θᵢₙₛₜ (third language model) (i.e., without generating the vocabulary-replacement instruction model g(θᵢₙₛₜ) (fourth language model)).

In the integrated model generation process illustrated in FIG. 9, furthermore, the merging processing includes the difference between the post-continued-pretraining instruction model θ'ᵢₙₛₜ (fifth language model) and the continued-pretraining model θ'_{base} (second language model). This enables the merged model θ_{merge} (integrated model) to correctly output a token that serves as a signal of the end of the dialogue of an LLM artificially added for instruction-following.

As described above, even when a vocabulary modification is applied to a base model and continued pretraining is further performed, a desired model that has acquired instruction-following capability can be generated.

Specifically, also through the integrated model generation process illustrated in FIG. 9, the server 12 can generate the merged model θ_{merge} (integrated model) including an effect of the instruction tuning used when the instruction model θᵢₙₛₜ (third language model) is generated, after applying a vocabulary modification to the base model θ_{base} and further performing continued pretraining. Thus, the server 12 can generate the merged model θ_{merge} (integrated model) that has acquired instruction-following capability while retaining characteristics of the continued-pretraining model θ'_{base} (second language model).

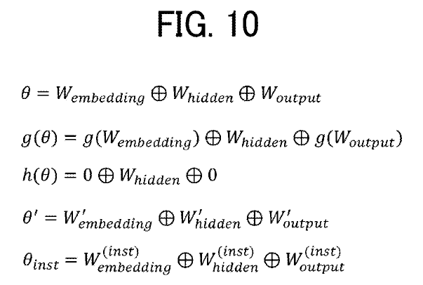

FIG. 10 is a diagram illustrating a relationship between each language model described in the present embodiment and an embedding layer.

As illustrated in FIG. 10, each language model (large language model) includes an input layer (W_embedding), an intermediate layer (W_hidden), and an output layer (W_output). A vocabulary modification is applied to the input layer (W_embedding) and the output layer (W_output) of the language model. A specific example of the vocabulary modification is as illustrated in FIG. 5. In instruction tuning and continued pretraining, in contrast, changes are made to all of the input layer (W_embedding), the intermediate layer (W_hidden), and the output layer (W_output) of the language model.

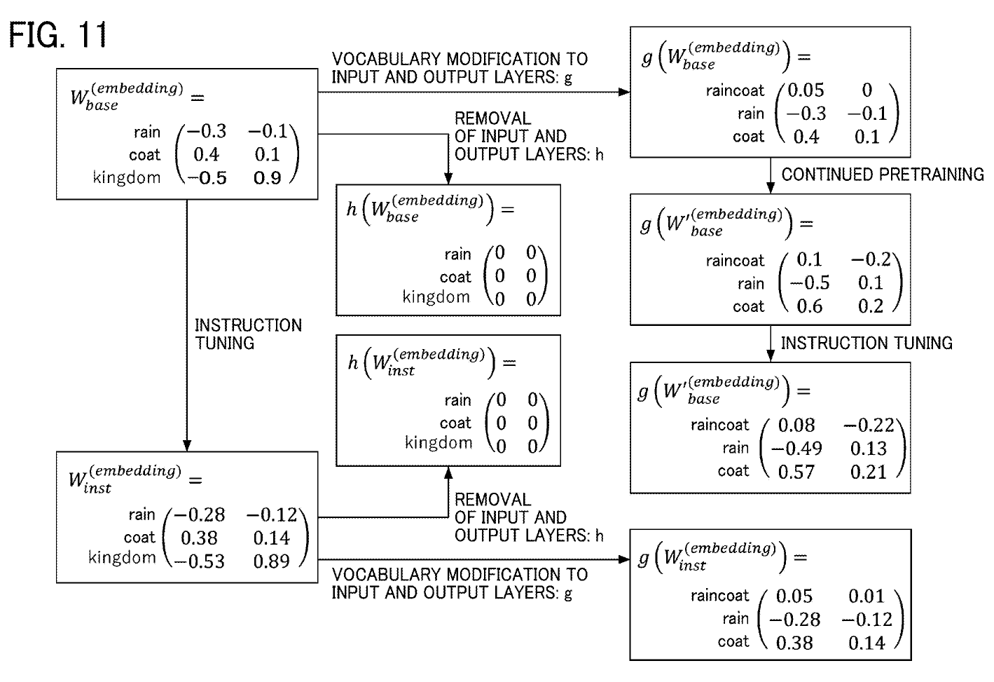

FIG. 11 is a diagram illustrating a change of the embedding layer in each language model described in the present embodiment. FIG. 11 illustrates an example in which the embedding layer of the base model has vectors corresponding to identifiers indicating the words “rain,” “coat,” and “kingdom,” and the embedding layer of the vocabulary-replacement base model has vectors corresponding to identifiers indicating the words “raincoat,” “rain,” and “coat.” These vocabulary items are representative vocabulary items extracted for understanding of the description. In practice, both the base model and the vocabulary-replacement base model have an enormous number of vocabulary items.

FIG. 11 also illustrates an example in which the merged model θ_{merge} (integrated model) is generated by using the integrated model generation process illustrated in FIG. 4. In FIG. 11, vectors linked to respective vocabulary items are two-dimensional, and thus, two-dimensional vectors of three vocabulary items are represented as a 3 × 2 matrix. In the example illustrated in FIG. 11, furthermore, the method illustrated in FIG. 5 is used as a vocabulary modification method. Thus, in the example illustrated in FIG. 11, in the embedding layers of models before and after the vocabulary modification, the same vector is associated with the identifiers indicating the words “rain” and “coat,” which are included in both the model before the vocabulary modification and the model after the vocabulary modification. In the embedding layer of the model after the vocabulary modification, an average of the vectors of the words “rain” and “coat” in the base model (i.e., the model before the vocabulary modification) is linked to the identifier indicating the word “raincoat,” which is newly added to the model after the vocabulary modification by using the vocabulary modification.

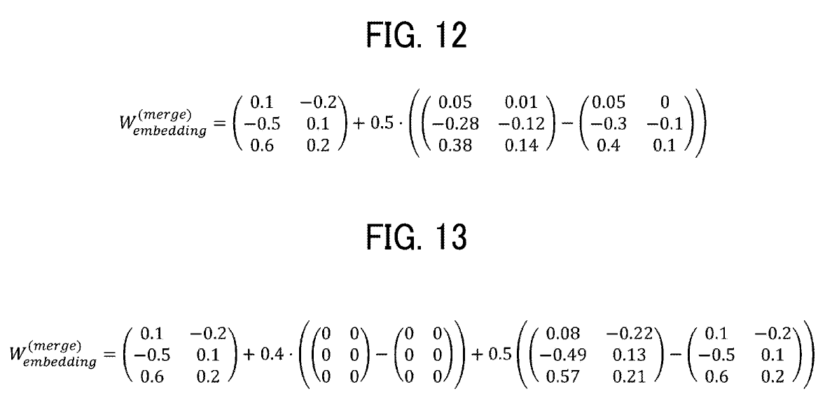

FIG. 12 illustrates a matrix of an embedding layer of a merged model (integrated model) generated by the server 12. FIG. 12 illustrates a matrix of an embedding layer of the merged model θ_{merge} (integrated model) generated when the integrated model generation process illustrated in FIG. 8 is used instead of the integrated model generation process illustrated in FIG. 4 in the embedding-layer changes illustrated in FIG. 11. In the illustrated example, the value of the coefficient α is set to 0.5.

FIG. 13 is a diagram illustrating another matrix of the embedding layer of the merged model (integrated model) generated by the server 12. FIG. 13 illustrates a matrix of an embedding layer of the merged model θ_{merge} (integrated model) generated when the integrated model generation process illustrated in FIG. 9 is used instead of the integrated model generation process illustrated in FIG. 4 in the embedding-layer changes illustrated in FIG. 11. In the illustrated example, the value of the coefficient α is set to 0.4. In the illustrated example, the value of the coefficient β is set to 0.5.

### Third Modification of Integrated Model Generation Process by Server 12

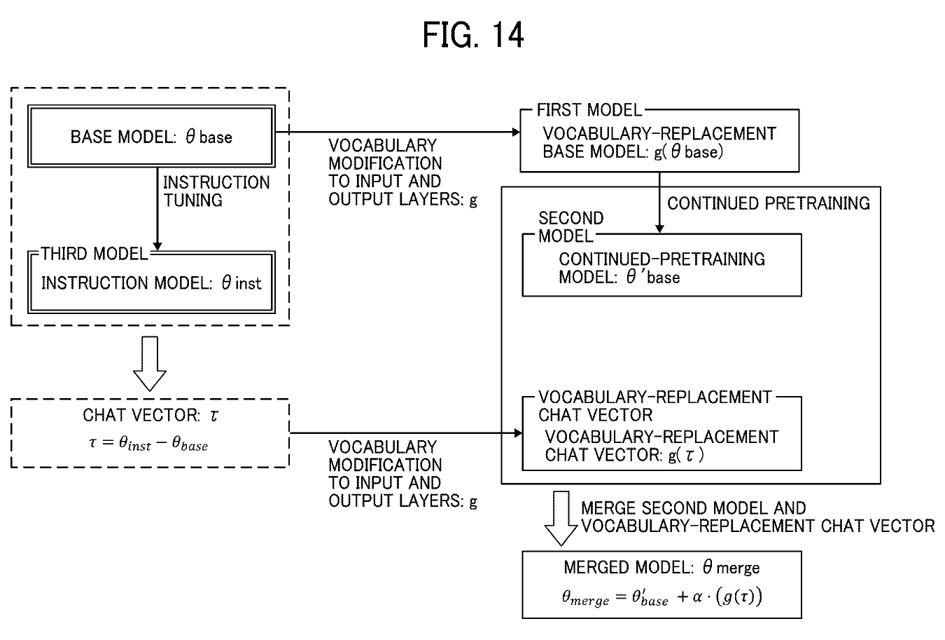

FIG. 14 is an illustration of a third modification of the integrated model generation process performed by the server 12.

The integrated model generation process illustrated in FIG. 14 is different from the integrated model generation process illustrated in FIG. 4 in the following points.

In the integrated model generation process illustrated in FIG. 14, the server 12 acquires a chat vector τ, which is generated based on the base model θ_{base} and the instruction model θᵢₙₛₜ (third language model). The chat vector τ may be provided in advance externally or may be generated by the server 12. The chat vector τ is a difference between the base model θ_{base} and the instruction model θᵢₙₛₜ (third language model).

The server 12 applies the vocabulary modification g to the chat vector τ to generate a vocabulary-replacement chat vector g(τ).

Thereafter, the server 12 merges the continued-pretraining model θ'_{base} (second language model) and the vocabulary-replacement chat vector g(τ) to generate a merged model θ_{merge} (integrated model).

The integrated model generation process illustrated in FIG. 14 enables generation of substantially the same merged model θ_{merge} (integrated model) as that in the integrated model generation process illustrated in FIG. 4. In particular, the integrated model generation process illustrated in FIG. 14 does not involve applying the vocabulary modification g to each of the base model and the instruction model, thereby reducing processing load as compared with the integrated model generation process illustrated in FIG. 4.

### UI Screen for Receiving Input of Dataset Used for Training

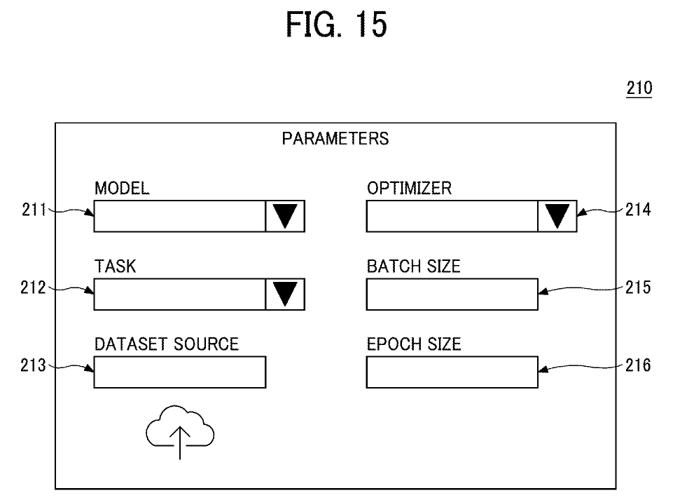

FIG. 15 is a diagram illustrating a UI screen displayed by the PC 14 for receiving input of a dataset.

The server 12 may acquire a dataset to be used for model training via the Internet, or may acquire the dataset by receiving input from a terminal apparatus such as the PC 14.

In a case where the server 12 acquires a dataset to be used for model training by receiving input from a terminal apparatus, the server 12 may cause a UI screen 210 illustrated in FIG. 15 to be displayed on the terminal apparatus, and may receive a dataset and training settings selected by a user on the UI screen 210 from the terminal apparatus. The server 12 may perform model training based on the dataset and the training settings received from the terminal apparatus. For example, the server 12 may perform continued pretraining for generating the second language model and instruction tuning for generating the fifth language model, based on the dataset and the training settings received from the terminal apparatus.

The UI screen 210 illustrated in FIG. 15 includes a model selection field 211, a task selection field 212, a dataset source setting field 213, an optimizer selection field 214, a batch size setting field 215, and an epoch size setting field 216.

The model selection field 211 is used by the user to select a model to be trained.

The task selection field 212 is used by the user to select a task to be performed by the model.

Examples of tasks include the following.

Text classification: classifying which category a text belongs to.

Named Entity Recognition (NER): extracting named entities such as personal names, place names, and organization names from a text.

Question Answering (QA): generating an answer to a given question.

Text summarization: generating a short summary of a long text.

Machine translation: translating a text in one language into another language.

The dataset source setting field 213 is used by the user to set a storage location of a dataset. For example, the dataset source setting field 213 may be set to “local” as an upload destination for a dataset. For example, the dataset source setting field 213 may be set to a uniform resource locator (URL) of a certain website as a storage location for a dataset.

The optimizer selection field 214 is used by the user to select an optimization algorithm for updating weights of a model. Examples of the optimization algorithm include Stochastic Gradient Descent (SGD), Adaptive Moment Estimation (Adam), Root Mean Square Propagation (RMSprop), and Adaptive Gradient Algorithm (Adagrad).

The batch size setting field 215 is used by the user to set a batch size (the number of data samples to be trained on at one time). The batch size setting field 215 is set to any integer value.

The epoch size setting field 216 is used by the user to set an epoch size (the number of times the entire dataset is used for training). The epoch size setting field 216 is set to any integer value.

### Example

The following describes an example of achieving a generative artificial intelligence (AI) chat using the LLM (integrated model generated by the server 12) described in the above-described embodiments.

### Functional Configuration of Server 12 and PC 14

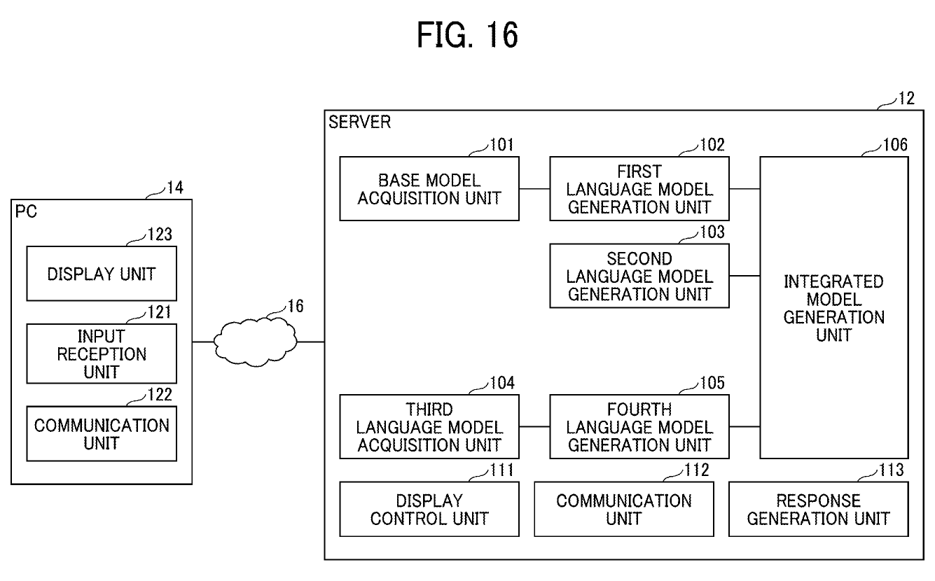

FIG. 16 is a block diagram of a functional configuration of the server 12 and the PC 14. The functional configuration illustrated in FIG. 16 is different from that in FIG. 3 in that the server 12 includes a response generation unit 113.

The response generation unit 113 inputs text entered by the user on the PC 14 into the LLM, and generates a response from an output of the LLM. The response generation unit 113 may generate the response by editing and correcting the output of the LLM, or may use the output of the LLM as the response as it is.

### Procedure of Generative AI Chat Process by Server 12 and PC 14

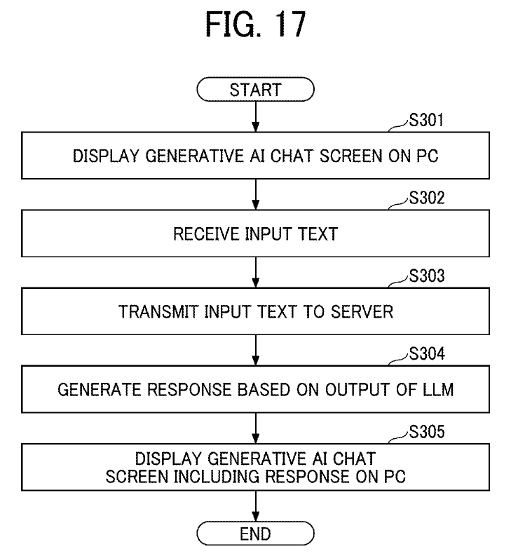

FIG. 17 is a flowchart of a procedure of a generative AI chat process performed by the server 12 and the PC 14 in one example.

First, in the server 12, the display control unit 111 transmits screen information of a generative AI chat screen to the PC 14 via the communication unit 112 to display the generative AI chat screen on the PC 14 (step S301). At this time, in the PC 14, the communication unit 122 receives the screen information of the generative AI chat screen, and the display unit 123 displays the generative AI chat screen.

Subsequently, in the PC 14, the input reception unit 121 receives input text from a user on the generative AI chat screen (step S302).

Subsequently, in the PC 14, the communication unit 122 transmits the input text received in step S302 to the server 12 (step S303).

Subsequently, in the server 12, the response generation unit 113 inputs the input text received from the PC 14 into the LLM, and uses an output of the LLM, which is obtained as a result of input, to generate a response to the input text entered by the user (step S304). The response generation unit 113 may use the output of the LLM as the response as it is, or may generate the response based on the output of the LLM.

Subsequently, in the server 12, the display control unit 111 transmits screen information of a generative AI chat screen including the response generated in step S304 to the PC 14 via the communication unit 112 to display the generative AI chat screen on the PC 14 (step S305). At this time, in the PC 14, the communication unit 122 receives the screen information of the generative AI chat screen, and the display unit 123 displays the generative AI chat screen.

Thereafter, the server 12 and the PC 14 end the series of processing operations illustrated in FIG. 17.

### Generative AI Chat Screens

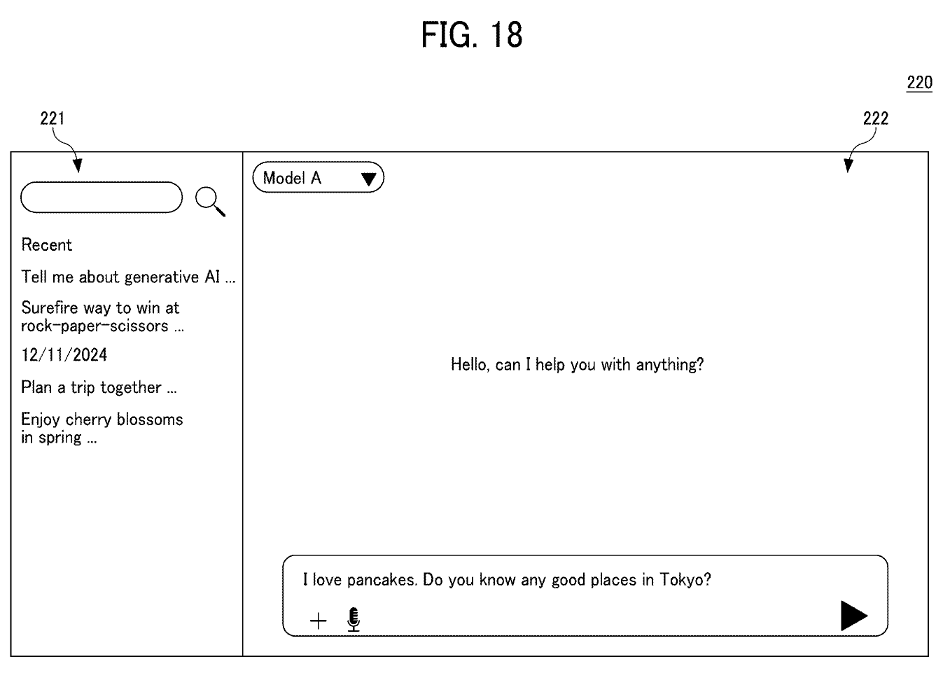

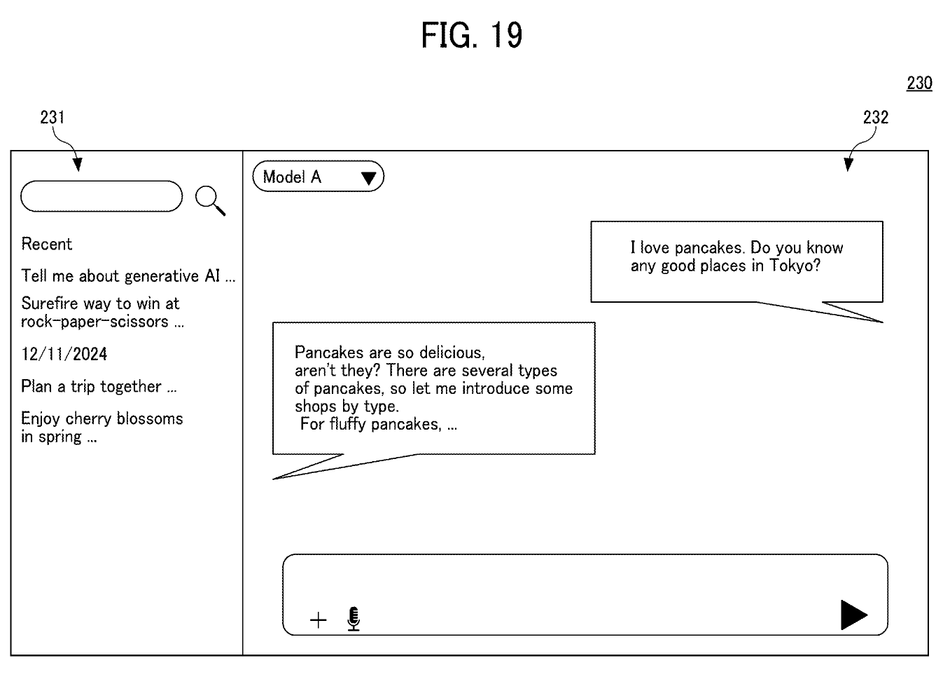

FIGS. 18 and 19 are diagrams illustrating generative AI chat screens displayed on the PC 14 in one example.

A generative AI chat screen 220 illustrated in FIG. 18 is displayed on the PC 14 under the control of the display control unit 111 of the server 12, and displays input text entered by the user.

In the example illustrated in FIG. 18, a model selection field is displayed at the top of a display area 222 on the right side of the generative AI chat screen 220. The model selection field allows the user to select a language model from an LLM.

In the example illustrated in FIG. 18, an input field at the bottom of the display area 222 on the right side of the generative AI chat screen 220 displays input text entered by the user. The input text states, "I love pancakes. Do you know any good places in Tokyo?" The user can send the input text to the server 12 by pressing a triangular send button displayed in the input field. The input field further displays a button for voice input and a button for file attachment. The user can enter the input text by voice or attach a file by pressing these buttons.

A generative AI chat screen 230 illustrated in FIG. 19 displays a response to the input text described above under the control of the display control unit 111 of the server 12. In the example illustrated in FIG. 19, a display area 232 on the right side of the generative AI chat screen 230 displays the input text entered by the user and the response generated by the response generation unit 113 of the server 12 for the input text in chronological order.

A display area 221 on the left side of the generative AI chat screen 220 and a display area 231 on the left side of the generative AI chat screen 230 display a generative AI chat history. The generative AI chat history may be categorized into several groups such as “Recent” and “12/11/2024” (a date representing December 11, 2024).

Each of the display areas 221 and 231 further displays a search field. The user enters a search word in the search field, and a generative AI chat history corresponding to the search word is displayed.

The server 12 and the PC 14 in one example perform a generative AI chat process by using the LLM (integrated model generated by the server 12) described in the above-described embodiments, thereby enhancing the performance of the model. Therefore, the accuracy of a response to input text can be enhanced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or DVD, and/or the memory of an FPGA or ASIC.

The apparatuses or devices described above in the example are one example of multiple computing environments that implement the embodiments disclosed herein. In some embodiments, the server 12 includes multiple computing devices, such as a server cluster. The multiple computing devices communicate with one another via any type of communication link including, for example, a network and a shared memory, and perform the processes disclosed herein. In one embodiment, the processes disclosed herein may be implemented by a single apparatus having both a functional configuration of a terminal apparatus and a functional configuration of an information processing apparatus.

The apparatuses or devices described above in the example are one example of multiple computing environments that implement the embodiments disclosed herein. In some embodiments, the server 12 includes multiple computing devices, such as a server cluster. The multiple computing devices communicate with one another via any type of communication link including, for example, a network and a shared memory, and perform the processes disclosed herein. In one embodiment, the processes disclosed herein may be implemented by a single apparatus having both a functional configuration of a terminal apparatus and a functional configuration of an information processing apparatus.

An information processing apparatus according to an aspect of the present disclosure includes an integrated model generation unit to generate an integrated model by integrating a second language model, a fifth language model, a first intermediate model, and a second intermediate model, the second language model being generated by performing continued pretraining on a first language model generated by applying a vocabulary modification to an input layer and an output layer of a base language model, the fifth language model being generated by performing instruction tuning on the second language model, the first intermediate model being generated by removing the input layer and the output layer of the base language model, the second intermediate model being generated by removing an input layer and an output layer of a third language model generated by performing instruction tuning on the base language model.

An information processing apparatus according to an aspect of the present disclosure includes an integrated model generation unit to generate an integrated model by integrating a second language model and a vocabulary-replacement chat vector, the second language model being generated by performing continued pretraining on a first language model generated by applying a vocabulary modification to an input layer and an output layer of a base language model, the vocabulary-replacement chat vector being generated by applying a vocabulary modification that is substantially the same as the vocabulary modification used for generation of the first language model to an input layer and an output layer of a chat vector that is a difference between the base language model and a third language model generated by performing instruction tuning on the base language model.

An information processing system according to an aspect of the present disclosure includes an integrated model generation unit to generate an integrated model by integrating a first language model, a second language model, and a fourth language model, the first language model being generated by applying a vocabulary modification to an input layer and an output layer of a base language model, the second language model being generated by performing continued pretraining on the first language model, the fourth language model being generated by applying a vocabulary modification that is substantially the same as the vocabulary modification used for generation of the first language model to an input layer and an output layer of a third language model generated by performing instruction tuning on the base language model.

An information processing system according to an aspect of the present disclosure includes an integrated model generation unit to generate an integrated model by integrating a second language model, a fifth language model, a first intermediate model, and a second intermediate model, the second language model being generated by performing continued pretraining on a first language model generated by applying a vocabulary modification to an input layer and an output layer of a base language model, the fifth language model being generated by performing instruction tuning on the second language model, the first intermediate model being generated by removing the input layer and the output layer of the base language model, the second intermediate model being generated by removing an input layer and an output layer of a third language model generated by performing instruction tuning on the base language model.

An information processing system according to an aspect of the present disclosure includes an integrated model generation unit to generate an integrated model by integrating a second language model and a vocabulary-replacement chat vector, the second language model being generated by performing continued pretraining on a first language model generated by applying a vocabulary modification to an input layer and an output layer of a base language model, the vocabulary-replacement chat vector being generated by applying a vocabulary modification that is substantially the same as the vocabulary modification used for generation of the first language model to an input layer and an output layer of a chat vector that is a difference between the base language model and a third language model generated by performing instruction tuning on the base language model.

An information processing method according to an aspect of the present disclosure includes generating an integrated model by integrating a second language model, a fifth language model, a first intermediate model, and a second intermediate model, the second language model being generated by performing continued pretraining on a first language model generated by applying a vocabulary modification to an input layer and an output layer of a base language model, the fifth language model being generated by performing instruction tuning on the second language model, the first intermediate model being generated by removing the input layer and the output layer of the base language model, the second intermediate model being generated by removing an input layer and an output layer of a third language model generated by performing instruction tuning on the base language model.

An information processing method according to an aspect of the present disclosure includes generating an integrated model by integrating a second language model and a vocabulary-replacement chat vector, the second language model being generated by performing continued pretraining on a first language model generated by applying a vocabulary modification to an input layer and an output layer of a base language model, the vocabulary-replacement chat vector being generated by applying a vocabulary modification that is substantially the same as the vocabulary modification used for generation of the first language model to an input layer and an output layer of a chat vector that is a difference between the base language model and a third language model generated by performing instruction tuning on the base language model.

A program according to an aspect of the present disclosure causes a computer to function as an integrated model generation unit to generate an integrated model by integrating a second language model, a fifth language model, a first intermediate model, and a second intermediate model, the second language model being generated by performing continued pretraining on a first language model generated by applying a vocabulary modification to an input layer and an output layer of a base language model, the fifth language model being generated by performing instruction tuning on the second language model, the first intermediate model being generated by removing the input layer and the output layer of the base language model, the second intermediate model being generated by removing an input layer and an output layer of a third language model generated by performing instruction tuning on the base language model.

A program according to an aspect of the present disclosure causes a computer to function as an integrated model generation unit to generate an integrated model by integrating a second language model and a vocabulary-replacement chat vector, the second language model being generated by performing continued pretraining on a first language model generated by applying a vocabulary modification to an input layer and an output layer of a base language model, the vocabulary-replacement chat vector being generated by applying a vocabulary modification that is substantially the same as the vocabulary modification used for generation of the first language model to an input layer and an output layer of a chat vector that is a difference between the base language model and a third language model generated by performing instruction tuning on the base language model.

1. An information processing apparatus comprising
circuitry configured to integrate a first language model, a second language model, and a fourth language model, to generate an integrated model,
the first language model being generated by applying a vocabulary modification to an input layer and an output layer of a base language model,
the second language model being generated by performing continued pretraining on the first language model,
the fourth language model being generated by applying a vocabulary modification that is substantially the same as the vocabulary modification used for generation of the first language model to an input layer and an output layer of a third language model, the third language model being generated by performing instruction tuning on the base language model.

2. The information processing apparatus according to claim 1,
wherein the circuitry is configured to add, to the second language model, a difference between the fourth language model and the first language model, to generate the integrated model.

3. The information processing apparatus according to claim 1,
wherein the circuitry is configured to add, to the second language model, a product of a coefficient and a difference between the fourth language model and the first language model, to generate the integrated model.

4. The information processing apparatus according to claim 1, wherein
a common vocabulary item is a vocabulary item that is common to a language model before the vocabulary modification and a language model after the vocabulary modification, and
in the vocabulary modification,
the common vocabulary item in the language model after the vocabulary modification is linked to a vector common to the common vocabulary item in the language model before the vocabulary modification, and
a vocabulary item added to the language model after the vocabulary modification is linked to an average of vectors of vocabulary items included in the language model before the vocabulary modification.

5. An information processing method comprising:
integrating a first language model, a second language model, and a fourth language model, to generate an integrated model,
the first language model being generated by applying a vocabulary modification to an input layer and an output layer of a base language model,
the second language model being generated by performing continued pretraining on the first language model,
the fourth language model being generated by applying a vocabulary modification that is substantially the same as the vocabulary modification used for generation of the first language model to an input layer and an output layer of a third language model, the third language model being generated by performing instruction tuning on the base language model.

6. A non-transitory recording medium storing a plurality of instructions which, when executed by one or more processors, causes the one or more processors to perform a method comprising:
integrating a first language model, a second language model, and a fourth language model, to generate an integrated model,
the first language model being generated by applying a vocabulary modification to an input layer and an output layer of a base language model,
the second language model being generated by performing continued pretraining on the first language model,
the fourth language model being generated by applying a vocabulary modification that is substantially the same as the vocabulary modification used for generation of the first language model to an input layer and an output layer of a third language model, the third language model being generated by performing instruction tuning on the base language model.
